(19) United States
(12) Patent Application Publication
(10) Pub. No.: US 2023/0285115 A1
(43) Pub. Date: Sep. 14, 2023

(54) DENTAL HANDPIECE

(71) Applicant: Kazuyoshi SUZUKI, CHIBA (JP)

(72) Inventor: Kazuyoshi SUZUKI, CHIBA (JP)

(21) Appl. No.: 18/013,984

(22) PCT Filed: Mar. 17, 2022
(86) PCT No.: PCT/JP2022/012458

§ 371 Date: Dec. 30, 2022

(30) Foreign Application Priority Data
Mar. 18, 2021 (JP) 2021-079351
Jun. 21, 2021 (JP) 2021-124823

(51) Int. Cl. A61C 1/07

(52) U.S. Cl. CPC A61C 1/07; A61C 2201/00

(57) ABSTRACT

Provided is a dental handpiece which can prevent degradation in visibility of a surgical field. The anti-reflection layer 100 is formed on the top surface and the side surface of the head portion 241 of the lid member 24 close to the root canal of the tooth, to which the operator pays attention, and further on the outer surface of the second cylindrical member 12 (refer to FIG. 3). Therefore, the reflection of light of a dental lighting tool provided with the anti-reflection layer 100 is suppressed, and degradation in visibility of a surgical field can be avoided. In addition, visibility of stains such as proteins adhering to the lid member 24 and the second cylindrical member 12 is improved, and cleaning thereof is facilitated.

### TECHNICAL FIELD

The present invention relates to a dental handpiece for driving a dental piece such as a file and/or a reamer attached to a tip portion in order to treat a root canal of a tooth.

### BACKGROUND ART

As a dental piece, the file and/or the reamer are generally used when performing a root canal treatment, such as scraping a wall surface of a root of a decayed tooth of a patient, removing a lump of pus and/or a filler clogged at a tip of the root, and/or removing nerves. For example, gutta-percha (root canal filler) is generally removed by using the files.

### SUMMARY OF INVENTION

### Technical Problem

However, light of a dental lighting tool is reflected by a surface of a dental handpiece for driving the dental piece. Consequently, visibility of a surgical field is degraded, thereby causing a possibility that a workload of an operator may increase.

Therefore, an object of the present invention is to provide a dental handpiece capable of preventing degradation in visibility of a surgical field.

### SOLUTION TO PROBLEM

According to the present invention, there is provided a dental handpiece including a support mechanism that supports a dental piece to be capable of vibrating. Wherein an anti-reflection layer that suppresses light reflection is at least partially formed on a surface of at least one member having an exposed surface and constituting the support mechanism.

In the dental handpiece having the above-described configuration, it is preferable that the anti-reflection layer is configured to include a carbon coating layer, a ceramic coating layer, a blasting mark, or a combination thereof.

In the dental handpiece having the above-described configuration, it is preferable that the support mechanism is configured to include a vibration cylinder that accommodates the dental piece in a state where the dental piece protrudes from one end side through a through-hole, a lid member that closes the other end side of the vibration cylinder, and a support cylinder into which the vibration cylinder is inserted to be displaceable in an axial direction, and the anti-reflection layer is formed on a surface of the lid member.

### BRIEF DESCRIPTION OF DRAWINGS

FIG. 1 is a configuration diagram illustrating a dental handpiece as a first embodiment of the present invention.

FIG. 2 is a configuration diagram illustrating a main portion of the dental handpiece in FIG. 1.

FIG. 3 is a configuration diagram illustrating a lid member of the dental handpiece in FIG. 1.

FIG. 4 is a configuration diagram illustrating a dental handpiece as a second embodiment of the present invention.

### DESCRIPTION OF EMBODIMENTS

### First Embodiment (Configuration)

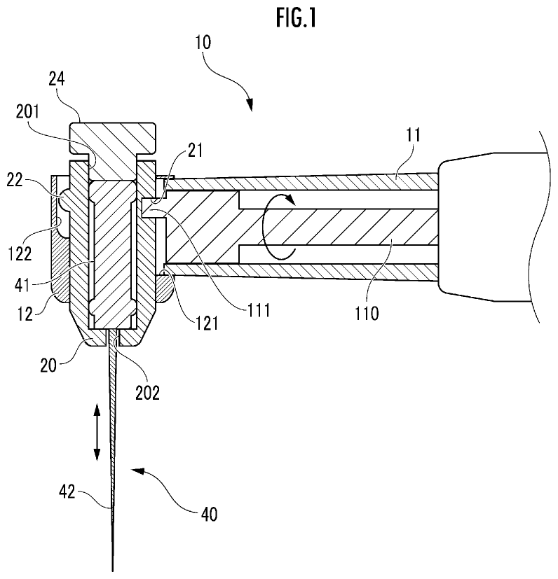

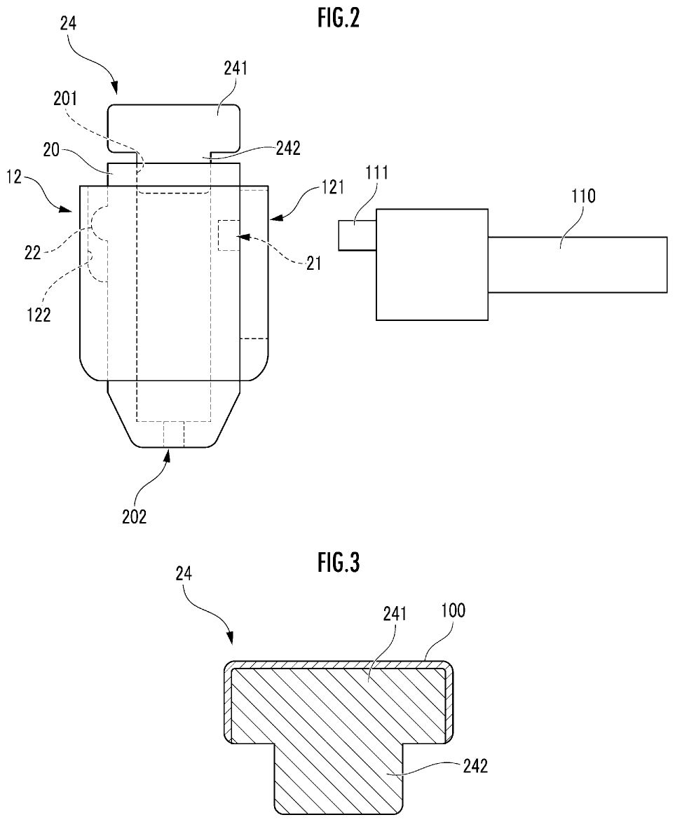

A dental handpiece 10 as a first embodiment of the present invention schematically illustrated in FIG. 1 is configured to drive a file 40 (or a reamer) as a dental piece. The dental handpiece 10 includes a first cylindrical member 11, a second cylindrical member 12 (support cylinder), and a vibration cylinder 20. The first cylindrical member 11 is formed in a substantially cylindrical shape. The second cylindrical member 12 is formed in a substantially cylindrical shape, and the vibration cylinder 20 is connected to a side wall of a tip portion of the first cylindrical member 11 in a posture in which a central axis of the second cylindrical member 12 forms a constant angle (for example, an angle range of 90° to 120°) or intersects with a central axis of the first cylindrical member 11. The vibration cylinder 20 is inserted into an internal space of the second cylindrical member 12 to be capable of vibrating in a posture substantially coaxial with the second cylindrical member 12 and in a direction parallel to the central axis of the second cylindrical member 12 (upward-downward direction in FIGS. 1 and 2).

The first cylindrical member 11, the second cylindrical member 12, and the vibration cylinder 20 are formed of metal such as aluminum alloy and stainless steel. The first cylindrical member 11 and the second cylindrical member 12 are integrally formed of the same metal. The vibration cylinder 20 may be formed of the metal the same as that of the first cylindrical member 11 and the second cylindrical member 12, or may be formed of a different metal.

As illustrated in FIG. 1, a substantially cylindrical rotating member 110 is disposed in the internal space of the first cylindrical member 11 in a posture in which the central axis of the rotating member 110 extends parallel to or substantially parallel to a longitudinal direction of the first cylindrical member 11. A tip portion of the rotating member 110 is formed in a substantially cylindrical shape having a relatively large diameter. As illustrated in FIGS. 1 and 2, the tip portion is provided with a cam pin 111 eccentric with respect to the central axis of the rotating member 110 and protruding in a direction parallel to the central axis. A pin mounting hole extending parallel to the central axis may be formed in the tip portion of the rotating member 110, and the cam pin 111 may be detachably mounted on the pin mounting hole. The rotating member 110 is connected to a rotary shaft of an electric motor of a chair unit and is configured to be driven to rotate around the central axis. For example, a switch for controlling an operation of the electric motor to be turned on/off is configured to include a foot-operated foot switch (not illustrated).

As illustrated in FIG. 1, the internal space of the first cylindrical member 11 and the internal space of the second cylindrical member 12 communicate with each other through a communication hole 121 formed on a side wall of the second cylindrical member 12. As illustrated in FIGS. 1 and 2, inside the side wall of the second cylindrical member 12, a guide groove 122 recessed while extending parallel to the central axis is formed at an azimuth angle position (for example, an opposite side) different from that of the communication hole 121 with reference to the central axis of the second cylindrical member 12.

As illustrated in FIGS. 1 and 2, a cam hole 21 (cam recessed portion) locally recessed in a radial direction is formed outside the side wall of the vibration cylinder 20. A guide pin 22 protruding in the radial direction from an azimuth angle position (for example, an opposite side) different from that of the cam hole 21 with reference to the central axis is provided outside the side wall of the vibration cylinder 20. The cam pin 111 of the rotating member 110 is fitted into the cam hole 21 of the vibration cylinder 20. The cam hole 21 is formed to be wider than the cam pin 111 in a circumferential direction so that a clearance is formed between the cam pin 111 and the cam hole 21 in the circumferential direction (and in an axial direction, when necessary) of the vibration cylinder 20. The guide pin 22 of the vibration cylinder 20 is fitted into the guide groove 122 of the second cylindrical member 12. The guide groove 122 is formed to be wider than the guide pin 22 in the circumferential direction so that a clearance (which may be smaller than the clearance between the cam pin 111 and the cam hole 21) is formed between the guide pin 22 and the guide groove 122 in the circumferential direction of the vibration cylinder 20.

As illustrated in FIGS. 1 and 2, the internal space of the vibration cylinder 20 communicates with an external space through a mounting port 201 on one end side, and communicates with an external space through a through-hole 202 having a diameter smaller than that of the mounting port 201 on the other end side. One end side of the internal space of the vibration cylinder 20 is closed by mounting a lid member 24 on the mounting port 201. As illustrated in FIG. 2, the lid member 24 is configured to include a substantially disk-shaped head portion 241 and a substantially cylindrical mounting portion 242 protruding from one end of the head portion 241. A female screw is formed inside the side wall in the mounting port 201 of the vibration cylinder 20, and a male screw screwed into the female screw is formed on a side surface of the mounting portion 242 of the lid member 24. The female screw of the vibration cylinder 20 and the male screw of the lid member 24 may be omitted, and the mounting portion 242 of the lid member 24 may be fitted to the vibration cylinder 20 by being brought into pressurized contact with the inside of the side wall of the vibration cylinder 20. The lid member 24 is formed of metal such as aluminum alloy and stainless steel.

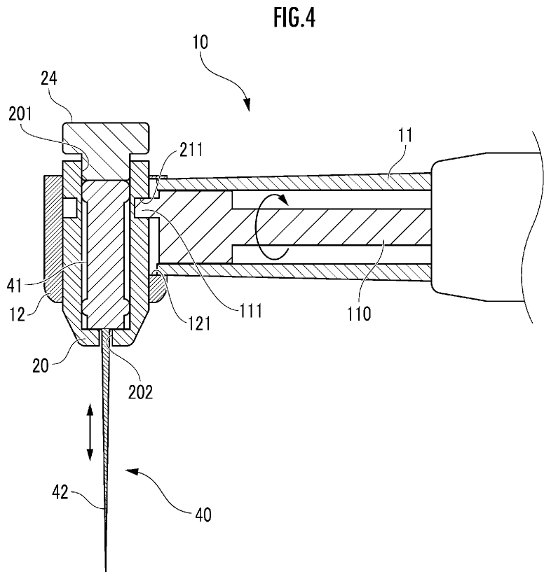

As illustrated in FIG. 3, in a longitudinal sectional view of the lid member 24, an anti-reflection layer 100 is formed over an entire top surface (end surface on a side opposite to the mounting portion 242) and an entire periphery of the side surface of the head portion 241. The anti-reflection layer 100 is configured to include a carbon coating layer, a ceramic coating layer, a blasting mark, a combination thereof, an anti-reflection film, or an anti-reflection coating agent. The carbon coating layer may be configured to include a diamond-like carbon (DLC) thin film or a graphite thin film. For example, the ceramic coating layer may be configured to include Al₂O₃ (alumina), Y₂O₃ (yttria), TiO₂ (titania), or a ceramic sprayed film whose raw material is a combination of the ceramics and zirconia. The blasting mark is formed in such a way that blasting particles having hardness higher than that of a base material (metal) of the lid member 24 or a coating layer formed on a surface of the base material (for example, particles having an average particle size of 10 to 100 μm) collide with the base material or the coating layer at high speed.

Similarly, the anti-reflection layer 100 is formed on an entire outer surface of the second cylindrical member 12. The anti-reflection layer 100 may be formed on an entire outer surface of the first cylindrical member 11 or in a region located on a front side during surgery (for example, an upper half portion in FIG. 1).

As illustrated in FIGS. 1 and 2, the file 40 includes a needle substrate 41 and a needle portion 42. The needle portion 42 is fixed to the needle substrate 41 to protrude in the axial direction from one end side of the substantially cylindrical needle substrate 41. The needle portion 42 is formed so that the diameter gradually decreases from a base end portion to a tip portion. The file 40 is mounted on the vibration cylinder 20 in a state where the needle substrate 41 is accommodated in the internal space of the vibration cylinder 20 and the needle portion 42 partially protrudes from the through-hole 202. The needle substrate 41 comes into contact with a stepped portion of the through-hole 202 on one end side, and comes into contact with an end portion of the mounting portion 242 of the lid member 24 on the other end side. In this manner, the needle substrate 41 and the file 40 are fixed to the vibration cylinder 20. The needle portion 42 may be flexible or bendable.

In the present embodiment, a support mechanism that supports the file 40 (dental piece) to be capable of vibrating is configured to include the second cylindrical member 12, the vibration cylinder 20, and the lid member 24.

### Function

When the rotating member 110 is rotationally driven, a vibrating force acts on the vibration cylinder 20 in a central axis direction through the cam pin 111, and the guide pin 22 is guided along the guide groove 122 of the second cylindrical member 12. In this manner, the vibration cylinder 20 is driven to vibrate in the axial direction with respect to the second cylindrical member 12. In addition, the needle portion 42 protruding from the through-hole 202 of the vibration cylinder 20 vibrates. Therefore, the operator can perform a root canal treatment by bringing the vibrating needle portion 42 into contact with a target site of the tooth of the patient.

### Second Embodiment (Configuration)

The dental handpiece 10 as a second embodiment of the present invention illustrated in FIG. 4 has a configuration substantially the same as that of the dental handpiece 10 as the first embodiment of the present invention illustrated in FIGS. 1 to 3. Common reference numerals will be assigned to common configurations, and descriptions thereof will be omitted.

As illustrated in FIG. 4, instead of the cam hole (refer to the reference numeral 21 in FIG. 1) of the first embodiment, a substantially annular cam groove 211 (cam recessed portion) extending over the entire circumferential direction is formed outside the side wall of the vibration cylinder 20. The cam pin 111 of the rotating member 110 is fitted into the cam groove 211 of the vibration cylinder 20. The cam groove 211 may be formed outside the side wall of the vibration cylinder 20 in an annular shape extending in the circumferential direction over a partial range (for example, 0° to 350°) of an azimuth angle range of 0° to 360° with reference to the central axis of the vibration cylinder 20 while being intermittent at one location. Unlike the first embodiment, the guide groove (refer to the reference numeral 122 in FIG. 1) inside the side wall of the second cylindrical member 12 and the guide pin (refer to the reference numeral 22 in FIG. 1) outside the side wall of the vibration cylinder 20 are omitted.

### Function

When the rotating member 110 is rotationally driven, a vibrating force acts on the vibration cylinder 20 in a central axis direction through the cam pin 111, and the guide pin 22 is guided along the guide groove 122 of the second cylindrical member 12. In this manner, the vibration cylinder 20 is driven to vibrate in the axial direction with respect to the second cylindrical member 12. Furthermore, the vibration cylinder 20 pivots circumferentially relative to the cam pin 111 along the cam groove 211. In this manner, the needle portion 42 protruding from the through-hole 202 of the vibration cylinder 20 pivots around the axial direction while vibrating in the axial direction. Therefore, the operator can perform a root canal treatment by bringing the needle portion 42 into contact with a target site of the tooth of the patient.

Since the needle portion 42 is bendable, the needle portion 42 can be inserted into a root canal having a different shape depending on the patient and depending on the tooth, and thus, work for the root canal treatment can be facilitated. Even when there is resistance against a reciprocating motion of the file 40, or when the needle portion 42 may be bitten into the root canal, the case can be avoided. The needle portion 42 is less likely to be twisted and/or bent, and the reciprocating motion can be smoothly continued.

The anti-reflection layer 100 is formed on the top surface and the side surface of the head portion 241 of the lid member 24 close to the root canal of the tooth, to which the operator pays attention, and further on the outer surface of the second cylindrical member 12 (refer to FIG. 3). Therefore, the reflection of light of a dental lighting tool provided with the anti-reflection layer 100 is suppressed, and degradation in visibility of a surgical field can be avoided. In addition, visibility of stains such as proteins adhering to the lid member 24 and the second cylindrical member 12 is improved, and cleaning thereof is facilitated.

### Description of Reference Numerals

10: dental handpiece

11: first cylindrical member

12: second cylindrical member (support cylinder)

20: vibration cylinder

21: cam hole (cam recessed portion)

22: guide pin

24: lid member

40: file (dental piece)

41: needle substrate

42: needle portion

100: anti-reflection layer

110: rotating member

111: cam pin (cam protruding portion)

121: communication hole

122: guide groove

201: mounting port

202: through-hole

211: cam groove

241: head portion

242: mounting portion

1. A dental handpiece comprising:
a support mechanism that supports a dental piece to be capable of vibrating,
wherein an anti-reflection layer that suppresses light reflection is at least partially formed on a surface of at least one member having an exposed surface and constituting the support mechanism.

2. The dental handpiece according to claim 1,
wherein the anti-reflection layer is configured to include a carbon coating layer, a ceramic coating layer, a blasting mark, or a combination thereof.

3. The dental handpiece according to claim 1,
wherein the support mechanism is configured to include a vibration cylinder that accommodates the dental piece in a state where the dental piece protrudes from one end side through a through-hole, a lid member that closes the other end side of the vibration cylinder, and a support cylinder into which the vibration cylinder is inserted to be displaceable in an axial direction, and
the anti-reflection layer is formed on a surface of the lid member.

4. The dental handpiece according to claim 2,
wherein the support mechanism is configured to include a vibration cylinder that accommodates the dental piece in a state where the dental piece protrudes from one end side through a through-hole, a lid member that closes the other end side of the vibration cylinder, and a support cylinder into which the vibration cylinder is inserted to be displaceable in an axial direction, and
the anti-reflection layer is formed on a surface of the lid member.
